(19) United States
(12) Patent Application Publication
(10) Pub. No.: US 2014/0043461 A1
(43) Pub. Date: Feb. 13, 2014

(54) IMAGE PROCESSING DEVICE, IMAGE PROCESSING METHOD, IMAGE PROCESSING PROGRAM, AND VIRTUAL MICROSCOPE SYSTEM

(71) Applicant: OLYMPUS CORPORATION, Tokyo (JP)

(72) Inventor: Takeshi OTSUKA, Tokyo (JP)

(73) Assignee: OLYMPUS CORPORATION, Tokyo (JP)

(21) Appl. No.: 14/059,969

(22) Filed: Oct. 22, 2013

Related U.S. Application Data
(63) Continuation of application No. PCT/JP2012/059423, filed on Mar. 30, 2012.

(30) Foreign Application Priority Data
Apr. 28, 2011 (JP) 2011-102477

(51) Int. Cl. G06T 7/00

(52) U.S. Cl. CPC G06T 7/0012
USPC 348/79; 382/133

(57) ABSTRACT

An image processing device for processing a stained sample image including hematoxylin stain is provided with a dye spectrum storage unit that stores a dye spectrum of dye used in staining, a change characteristic calculation unit that calculates a change characteristic in a wavelength direction of the dye spectrum based on the dye spectrum, a dye amount/wavelength shift amount estimation unit that estimates at least a dye amount of the hematoxylin stain and a shift amount in the wavelength direction for each pixel in the stained sample image based on the dye spectrum and the change characteristic; and a cell nucleus extraction unit that extracts a cell nucleus region of the stained sample image based on the shift amount estimated in the wavelength direction.

### CROSS REFERENCE TO RELATED APPLICATION

The present application is a Continuing Application based on International Application PCT/JP2012/059423 filed on Mar. 30, 2012, which, in turn, claims the priority from Japanese Patent Application No. 2011-102477 filed on Apr. 28, 2011, the entire disclosure of these earlier applications being herein incorporated by reference.

### TECHNICAL FIELD

The present invention relates to an image processing device, an image processing method, an image processing program, and a virtual microscope system.

### BACKGROUND ART

A spectral transmittance spectrum is one physical quantity representing a physical property specific to an object. The spectral transmittance is a physical quantity representing a ratio of transmitted light to incident light at each wavelength and is specific to an object, having a value that does not change due to extrinsic influences, unlike color information such as an RGB value that varies depending on changes in illumination light. Spectral transmittance is therefore used in various fields as information to reproduce the color of an object itself. For example, in the field of pathological diagnosis that uses tissue samples, particularly pathological specimens, spectral transmittance is used as an example of a spectral characteristic value for analyzing images obtained by imaging samples. Examples of using spectral transmittance for pathological diagnosis are described below in further detail.

One well-known pathological examination for pathological diagnosis is tissue diagnosis, whereby tissue is taken from an area of lesion and is observed under a microscope to diagnose a disease or verify the extent of the lesion. This tissue diagnosis is also known as a biopsy and is widely performed by thinly cutting a block sample obtained by organ harvesting or a pathological specimen obtained by needle biopsy into slices several micrometers thick and observing the slices under magnification with a microscope to obtain various findings. Transmission observation using an optical microscope is one of the most common observation methods, because equipment is relatively inexpensive and easy to use, and because this method has been used traditionally for years. The sliced samples absorb and scatter almost no light and are nearly transparent and colorless. The samples are therefore generally stained with dye prior to observation.

Various staining methods have been proposed, their number reaching over a hundred. Particularly for pathological specimens, hematoxylin-eosin staining (hereinafter referred to as “HE staining”) that uses bluish-purple hematoxylin and red eosin as pigment is used as a standard staining method.

Hematoxylin is a natural substance extracted from plants and has no stainability itself. Hematin, however, which is an oxide of hematoxylin, is a basophilic dye and bonds with a negatively charged substance. Deoxyribonucleic acid (DNA) contained in the cell nucleus is negatively charged by a phosphate group contained therein as a structural component and therefore is stained bluish-purple upon bonding, with hematin. As described above, it is not hematoxylin, but rather its oxide, hematin, which has stainability. Since the name hematoxylin is commonly used for the dye, however, this name is used below as well.

On the other hand, eosin is an acidophilic dye and bonds with a positively charged substance. Amino acid and protein are charged negatively or positively depending on their pH environment and have a strong tendency to be charged positively in an acid environment. For this reason, acetic acid is sometimes added to an eosin solution. The protein contained in cytoplasm is stained a color between red and pale red upon bonding with eosin.

In a sample subjected to HE staining (a stained sample), cell nuclei, bone tissue, and the like are stained bluish-purple, whereas cytoplasm, connective tissue, red blood cells and the like are stained red, making the sample highly visible. As a result, an observer can discern the size; positional relationship, and the like of elements constituting tissue such as cell nuclei, thereby enabling the observer to determine the state of the sample morphologically.

In addition to visual inspection by the observer, the stained sample can also be observed by taking a multiband image of the stained sample and displaying the image on a display screen of an external device. When images are displayed on a screen, various processing is performed, such as for estimating the spectral transmittance at each point of the sample from the captured multiband image and for estimating the amount of dye with which the sample is stained based on the estimated spectral transmittance. The display image, which is an RGB image of the sample for display, is thus composed.

Methods of estimating the spectral transmittance at each point of the sample from the multiband image of the sample include, for example, principal component analysis and Wiener estimation. Wiener estimation is widely known as a linear filtering method for estimating an original signal from an observed signal on which noise is superimposed. This method minimizes errors in view of the statistical properties of the observed object and the characteristics of noise (observed noise). Because signals from a camera contain some sort of noise, Wiener estimation is an extremely useful method for estimating an original signal.

A conventional method of composing a display image from a multiband image of a sample is described below.

First, a multiband image of a sample is captured. For example, a multiband image may be captured with a frame sequential method while rotating a filter wheel to switch between 16 bandpass filters. In this way, a multiband image having pixel values for 16 bands at each point of the sample can be obtained. Although the dye is originally distributed three-dimensionally in a sample to be observed, the dye cannot be captured directly as a three-dimensional image with an ordinary transmission observation system, and illumination light that passes through the sample and is projected on an imaging element of a camera is observed as a two-dimensional image. Therefore, “each point” referred to above signifies a point on the sample corresponding to a pixel projected onto the imaging element.

For an arbitrary point (pixel) x of a captured multiband image, the relationship in Equation (1) below based on the response system of the camera holds between a pixel value g(x, b) in band b and the spectral transmittance t(x, λ) at the corresponding point of the sample.

g(x,b)=∫_{λ}f(b,λ)s(λ)e(λ)t(x,λ)dλ+n(b) (1)

In Equation (1), λ denotes wavelength, f(b, λ) denotes the spectral transmittance of the b^{th} filter; s(λ) denotes the spectral sensitivity characteristic of the camera, e(λ) denotes the spectral emission characteristic of the illumination, and n(b) denotes observation noise in the band b. Furthermore, b is a serial number for identifying the band and in this case is an integer satisfying the expression 1≦b≦16, Equation (2) below, obtained by discretizing Equation (1) in the wavelength direction, is used for actual calculation.

G(x)=FSET(x)+N (2)

In Equation (2), G(x) denotes a B×1 matrix corresponding to the pixel value g(x, b) at point x, where the number of sample points in the wavelength direction is D, and the number of bands is B (in this case, B=16). Similarly, T(x) denotes a D×1 matrix corresponding to t(x, λ), and F denotes a B×D matrix corresponding to f(b, λ). On the other hand, S denotes a diagonal D×D matrix, and a diagonal element corresponds to s(λ). Similarly, E denotes a diagonal D×D matrix, and a diagonal element corresponds to e(λ). N denotes a B×1 matrix corresponding to n(b). Note that in Equation (2), the variable b representing a band is not included because equations related to a plurality of bands are collected together using matrices. Furthermore, an integral of the wavelength λ is replaced by a product of matrices.

To simplify notation, a matrix H defined by Equation (3) below is introduced. The matrix H is also called a system matrix.

H=FSE (3)

Therefore, Equation (2) is replaced by Equation (4) below.

G(x)=HT(x)+N (4)

Next, the spectral transmittance at each point of the sample is estimated from the captured multiband image using Wiener estimation. The estimated value of the spectral transmittance (spectral transmittance data), \hat{T}(x), can be calculated by Equation (5) below. \hat{T} indicates that a, symbol, ̂ (hat), representing an estimated value, is placed over the letter T.

\hat{T}(x)=WG(x)(5)

W here is expressed by Equation (6) below and is referred to as a “Wiener estimation matrix” or “estimation operator used for Wiener estimation”:

W=R_{SS}H^{t}(HR_{SS}H^{t}+R_{NN})⁻¹ (6)

where ( )^{t} is a transpose matrix, and ( )⁻¹ is an inverse matrix.

In Equation (6), R_{SS} is a D×D matrix and represents an autocorrelation matrix for the spectral transmittance of the sample, and R_{NN} is a B×B matrix and represents an autocorrelation matrix for noise of the camera used for imaging.

After thus estimating spectral transmittance data \hat{T}(x), amounts of dyes at a corresponding point on the sample (sample point) are estimated based on \hat{T}(x). Three kinds of dyes are estimated: hematoxylin, eosin that stains cytoplasm, and eosin that stains red blood cells or an original dye of red blood cells that are not stained. These three kinds of dyes are abbreviated as dye H, dye E, and dye R, respectively. Strictly speaking, the red blood cells have an intrinsic color even when not stained, and after HE staining, the color of the red blood cells themselves and the color of eosin that has changed during the staining process are observed as being superposed on each other. Therefore, to be precise, the color resulting from this combination is referred to as dye R.

Generally, in a substance that transmits light, it is known that the Lambert-Beer law represented by Equation (7) below holds between an intensity I₀(λ) of incident light and an intensity I(λ) of emitted light at each wavelength λ.

$$\frac{I ( λ )}{{I}_{0} ( λ )} = {e}^{- k ( λ ) \cdot d} \qquad ( 7 )$$

In Equation (7), k(λ) denotes a value specific to a substance determined depending on the wavelength, and d denotes a thickness of the substance.

The left side of Equation (7) indicates a spectral transmittance t(λ), and hence Equation (7) can be replaced by Equation (8) below.

t(λ)=e^{-k(λ)·d} (8)

Furthermore, the spectral absorbance a(λ) is represented by Equation (9) below.

a(λ)=k(λ)·d (9)

Therefore, Equation (8) is replaced by Equation (10) below.

t(λ)=e^{-a(λ)} (10)

When an HE stained sample is stained with the three kinds of dyes H, E, and R, Equation (11) below holds at each wavelength λ by the Lambert-Beer law.

$$\frac{I ( λ )}{{I}_{0} ( λ )} = {e}^{- ( {k}_{H} ( λ ) \cdot {d}_{H} + {k}_{E} ( λ ) \cdot {d}_{E} + {k}_{R} ( λ ) \cdot {d}_{R} )} \qquad ( 11 )$$

In Equation (11), k_{H}(λ), k_{E}(λ), and k_{R}(λ) denote k(λ) corresponding to the dye H, the dye E, and the dye R respectively, and for example are dye spectra of respective dyes that stain the sample. Furthermore, d_{H}, d_{E}, and d_{R} each represent a virtual thickness of the dye H, the dye E, and the dye R, respectively, at each point on the sample corresponding to each image position of the multiband image. Dyes are dispersed in a sample, and thus the concept of thickness may not be accurate. The thickness serves, however, as an index of a relative dye amount indicating how much dye is present, as compared to when the sample is assumed to be stained with a single dye. That is, it can be said that d_{H}, d_{E}, and d_{R} indicate a dye amount of the dye H, dye E, and dye R, respectively. The values k_{H}(λ), k_{E}(λ), and k_{R}(λ) can be easily calculated with the Lambert-Beer law by preparing beforehand samples that are stained individually using the dye H, dye E, and dye R and measuring the spectral transmittance thereof with a spectrometer.

Equation (9) can be replaced by Equation (12) below, where the spectral transmittance at position x is t(x, λ) and the spectral absorbance at position x is a(x, λ).

a(x,λ)=k_{H}(λ)·d_{H}+k_{E}(λ)·d_{E}+k_{R}(λ)·d_{R} (12)

Equation (12) can be replaced by Equation (13) below where the estimated spectral transmittance at the wavelength λ of the spectral transmittance \hat{T}(x) estimated using Equation (5) is â(x, λ). Note that â indicates that a symbol, ̂, is placed over the letter a.

â(x,λ)=k_{H}(λ)·d_{H}+k_{E}(λ)·d_{E}+k_{R}(λ)·d_{R} (13)

In Equation (13), the unknown variables are the three variables d_{H}, d_{E}, and d_{R}. Therefore, these variables can be solved for when simultaneous equations are obtained from Equation (13) for at least three different wavelengths λ. To further improve accuracy, multiple regression analysis may be performed after obtaining simultaneous equations from Equation (13) for for or more different wavelengths λ. For example, simultaneous equations acquired from Equation (13) for three wavelengths λ₁, λ₂, and λ₃ can be expressed in a matrix as Equation (14) below.

$$( \begin{matrix}\hat{a} ( x , {λ}_{1} ) \\ \hat{a} ( x , {λ}_{2} ) \\ \hat{a} ( x , {λ}_{3} )\end{matrix} ) = ( \begin{matrix}{k}_{H} ( {λ}_{1} ) & {k}_{E} ( {λ}_{1} ) & {k}_{R} ( {λ}_{1} ) \\ {k}_{H} ( {λ}_{2} ) & {k}_{E} ( {λ}_{2} ) & {k}_{R} ( {λ}_{2} ) \\ {k}_{H} ( {λ}_{3} ) & {k}_{E} ( {λ}_{3} ) & {k}_{R} ( {λ}_{3} )\end{matrix} ) ( \begin{matrix}{d}_{H} \\ {d}_{E} \\ {d}_{R}\end{matrix} ) \qquad ( 14 )$$

Equation (14) is replaced by Equation (15) below.

Â(x)=Kd(x) (15)

In Equation (15), Â(x) is a D×1 matrix corresponding to â(x, λ), K is a D×3 matrix corresponding to k(λ), and d(λ) is a 3×1 matrix corresponding to d_{H}, d_{E}, and d_{R} at a point x, where the number of sample points in the wavelength direction is D. Note that Â indicates that a symbol, ̂ is placed over the letter A.

According to Equation (15), the dye amounts d_{H}, d_{E}, and d_{R} are calculated using the least square method. The least square method is a method of determining d(x) such that a square sum of errors is minimized in a single regression equation and can be calculated by Equation (16) below. In Equation (16), \hat{d}(x) is an estimated dye amount.

\hat{d}(x)=(K^{T}K)⁻¹K^{T}Â(x) (16)

Furthermore, when the estimated dye amounts \hat{d}_{H}, \hat{d}_{E}, and d_{R} estimated by Equation (16) are substituted into Equation (12), a restored spectral absorbance ã(x, λ) can be calculated by Equation (17) below. Note that ã indicates that a symbol, ~ (tilde), is placed over the letter a.

ã(x,λ)=k_{H}(λ)·\hat{d}_{H}+k_{E}(λ)·\hat{d}_{E}+k_{R}(λ)·\hat{d}_{R} (17)

An estimated error e(λ) in dye amount estimation is calculated based on the estimated spectral absorbance â(x, λ) and the restored spectral absorbance ã(x, λ) by Equation (18) below. Hereinafter, e(λ) is referred to as the residual spectrum.

e(λ)=â(x,λ)−ã(x,λ) (18)

Furthermore, the estimated spectral absorbance â(x, λ) can be represented by Equation (19) below using Equations (17) and (18).

â(x,λ)=k_{H}(λ)·\hat{d}_{H}+k_{E}(λ)·\hat{d}_{E}+k_{R}(λ)·\hat{d}_{R}+e(λ) (19)

The Lambert-Beer law formulates the attenuation of light transmitted through a semi-transparent substance assuming no refraction or scattering. However, in an actual stained sample, refraction and scattering can both occur. Therefore, when attenuation of light due to the stained sample is modeled only by the Lambert-Beer law, errors may occur along with the modeling.

However, it is quite difficult to construct a model including refraction or scattering in biological specimens, and doing so is infeasible in actual application. Therefore, unnatural color variation due to the physical model can be prevented by adding the residual spectrum, which is a modeling error including influences of refraction and scattering.

Namely, by calculating and correcting the dye amounts \hat{d}_{H}, \hat{d}_{E}, and \hat{d}_{R}, the change in the dye amounts within the sample can be simulated. In the following explanation, it is assumed that the dye amounts \hat{d}_{H} and \hat{d}_{E} resulting from staining with a staining method are corrected, whereas the dye amount d_{R}, which is the original color of red blood cells, is not corrected. Letting the corrected dye amounts for the dye amounts \hat{d}_{H} and \hat{d}_{E} be \hat{d}_{H}* and \hat{d}_{E}* respectively, the corrected dye amounts \hat{d}_{H}* and \hat{d}_{E}* are calculated with Equation (20) below using appropriate coefficients α_{H} and α_{E}.

\hat{d}_{H}*=α_{H}\hat{d}_{H}

\hat{d}_{E}*=α_{E}\hat{d}_{E} (20)

Substituting the corrected dye amounts \hat{d}_{H}* and \hat{d}_{E}* of Equation (20) into Equation (12), a new spectral absorbance ã*(x, λ) can be calculated with Equation (21) below.

ã*(x,λ)=k_{H}(λ)·\hat{d}_{H}*+k_{E}(λ)·\hat{d}_{E}*+k_{R}(λ)·\hat{d}_{R} (21)

Furthermore, by including the residual spectrum, a new spectral absorbance â*(x, λ) can be calculated with Equation (22) below.

â*(x,λ)=k_{H}(λ)·\hat{d}_{H}*+k_{E}(λ)·\hat{d}_{E}*+k_{R}(λ)·\hat{d}_{R}+e(λ) (22)

By substituting the spectral absorbance ã*(x, λ) of Equation (21) and the spectral absorbance â*(x, λ) of Equation (22) into Equation (10), a new spectral transmittance t*(x, λ) can be calculated with Equation (23) below. Note that in Equation (23) below, the spectral absorbance a*(x, λ) is either ã*(x, λ) or â(x, λ).

t*(x,λ)=^{-a}*^{(x,λ)} (23)

By substituting Equation (23) into Equation (1), a new pixel value g*(x, b) can be calculated with Equation (24) below. In this case, calculation may be made with the observation noise n(b) as zero.

g*(x,b)=∫_{λ}f(b,λ)s(λ)e(λ)t*(x,λ)dλ (24)

Furthermore, Equation (4) is replaced by Equation (25) below.

G*(x)=HT*(x) (25)

In Equation (25), G*(x) is a B×1 matrix corresponding to g*(x, b), and T*(x) is a D×1 matrix corresponding to t*(x, λ). As a result, the pixel value G*(x) of a sample for which the dye amounts have been virtually changed can be composed. With the above processing, the dye amounts of the stained sample can be adjusted virtually.

Meanwhile, as a method for extracting a cell nucleus from an HE stained sample image, a method for extracting a cell nucleus region based on the dye amount of the H stain is known (for example, see JP2004-286666A (PTL 1)). With the method disclosed in PTL 1, pixels for which the H dye amount is greater than a threshold are identified as the cell nucleus.

Furthermore, as a method for correcting the dye amounts in a stained sample image, a method for correcting the staining condition of the stained sample image to conform to a standard is known (for example, see JP2009-014355A (PTL 2)). In the method disclosed in PTL 2, the pixels in a stained sample image are clustered based on dye amounts, and the dye amounts in each cluster are corrected to the dye amounts of a standard staining condition, thereby correcting the staining condition of the stained sample image to conform to a standard.

Furthermore, a phenomenon whereby the dye spectrum of the E stain shifts to a higher or lower wavelength depending on differences in tissues has been experimentally confirmed. Therefore, a method for calculating the shift amount of the dye spectrum, of the E stain and separating between cytoplasm and fiber based on the calculated shift amount has, been proposed (for example, see “Fiber region detection using absorbance spectrum shift from HE stain specimen”, Tomokatsu Miyazawa et al., Proceedings of Optics & Photonics Japan 2008, pp. 354-355, November 2008 (NPL 1)). In the method disclosed in NPL 1, the shift amount is calculated by a first-order approximation of the shift in the E stain when estimating the dye amount.

### CITATION LIST

### Patent Literature

PTL 1: JP2004-286666A
PTL 2: JP2009-014355A

### Non-Patent Literature

NPL 1: Fiber region detection using absorbance spectrum shift from HE stain specimen, Tomokatsu Miyazawa et al., Proceedings of Optics & Photonics Japan 2008, pp. 354-355, November 2008.

### SUMMARY OF INVENTION

An image processing device according to a first aspect of the present invention is an image processing device for processing a stained sample image including hematoxylin stain, comprising: a dye spectrum storage unit configured to store a dye spectrum of dye used in staining; a change characteristic calculation unit configured to calculate a change characteristic in a wavelength direction of the dye spectrum based on the dye spectrum; a dye amount/wavelength shift amount estimation unit configured to estimate at least a dye amount of the hematoxylin stain and a shift amount in the wavelength direction for each pixel in the stained sample image based on the dye spectrum and the change characteristic; and a cell nucleus extraction unit configured to extract a cell nucleus region of the stained sample image based on the shift amount estimated in the wavelength direction.

A second aspect of the present invention is the image processing device according to the first aspect, further comprising; a dye amount standard value storage unit configured to store a dye amount standard value for a cell nucleus; a dye amount correction coefficient calculation unit configured to calculate a dye amount correction coefficient for a cell nucleus in order to correct a dye amount of the cell nucleus region extracted by the cell nucleus extraction unit to be the dye amount standard value; and a dye amount correction unit configured to correct the dye amount of each pixel based on the dye amount correction coefficient.

A third aspect of the present invention is the image processing device according to the first or second aspect, further comprising, further comprising: a spectrum estimation unit configured to estimate a spectrum from a pixel value of each pixel in the stained sample image, wherein the dye amount/wavelength shift amount estimation unit estimates the shift amount in the wavelength direction based additionally on the spectrum estimated by the spectrum estimation unit.

A fourth aspect, of the present invention is the image processing device according to the first, second, or third aspect, further comprising: a display image creation unit configured to create a display image based on information on the cell nucleus region extracted by the cell nucleus extraction unit.

A method for image processing according to a fifth aspect of the present invention is a method for image processing to process a stained sample image including hematoxylin stain, comprising the steps of: acquiring a dye spectrum of dye used in staining; calculating a change characteristic in a wavelength direction of the dye spectrum based on the dye spectrum; estimating at least a dye amount of the hematoxylin stain and a shift amount in the wavelength direction for each pixel in the stained sample image based on the dye spectrum and the change characteristic; and extracting a cell nucleus region of the stained sample image based on the shift amount estimated in the wavelength direction.

A program for image processing according to a sixth aspect of the present invention is a program for image processing to process a stained sample image including hematoxylin stain, the program causing a computer to perform the steps of acquiring a dye spectrum of dye used in staining; calculating a change characteristic in a wavelength direction of the dye spectrum based on the dye spectrum; estimating at least a dye amount of the hematoxylin stain and a shift amount in the wavelength direction for each pixel in the stained sample image based on the dye spectrum and the change characteristic; and extracting a cell nucleus region of the stained sample image based on the shift amount estimated in the wavelength direction.

A virtual microscope system according to a seventh aspect of the present invention is a virtual microscope system for acquiring a virtual slide image of a stained sample, comprising: an image acquisition unit configured to acquire a stained sample image by imaging the stained sample using a microscope; a dye spectrum storage unit configured to store a dye spectrum of dye used in staining; a change characteristic calculation unit configured to calculate a change characteristic in a wavelength direction of the dye spectrum based on the dye spectrum; a dye amount/wavelength shift amount estimation unit configured to estimate at least a dye amount of the hematoxylin stain and a shift amount in the wavelength direction for each pixel in the stained sample image based on the dye spectrum and the change characteristic; and a cell nucleus extraction unit configured to extract a cell nucleus region of the stained sample image based on the shift amount estimated in the wavelength direction, wherein the virtual slide image of the stained sample is acquired based on information on the cell nucleus region extracted by the cell nucleus extraction unit.

### BRIEF DESCRIPTION OF DRAWINGS

The present invention will be further described below with reference to the accompanying drawings, wherein:

FIG. 1 is a block diagram illustrating the functional structure of main portions of an image processing device according to Embodiment 1 of the present invention;

FIG. 2 shows the schematic structure of the image acquisition unit in FIG. 1;

FIG. 3 illustrates the spectral sensitivity characteristics of the RGB camera in FIG. 2;

FIG. 4 illustrates the spectral transmittance characteristics of each optical filter contained in the filter unit in FIG. 2;

FIG. 5 illustrates the absorbance spectra of the cell nucleus and cytoplasm in a sample with simple H staining;

FIG. 6 is a flowchart providing an overview of operations by the image processing device in FIG. 1;

FIG. 7 illustrates the dye spectrum of the H stain stored in the dye spectrum storage unit in FIG. 1 and the first derivative thereof, i.e. a change characteristic;

FIG. 8 is a flowchart providing an overview of the image analysis processing in FIG. 6;

FIG. 9 illustrates conventional cell nucleus extraction processing;

FIG. 10 illustrates an example of cell nucleus extraction processing by the image processing device in FIG. 1;

FIG. 11 is a block diagram illustrating the functional structure of main portions of an image processing device according to Embodiment 2 of the present invention;

FIG. 12 is a flowchart providing an overview of operations by the image processing device in FIG. 11; and

FIG. 13 is a block diagram illustrating the functional structure of main portions of a virtual microscope system according to Embodiment 3 of the present invention.

### DESCRIPTION OF EMBODIMENTS

The following describes preferred embodiments of the present invention in detail with reference to the figures. Note that the present invention is not limited to the following embodiments. Furthermore, identical components in the drawings bear the same reference numbers.

### Embodiment 1

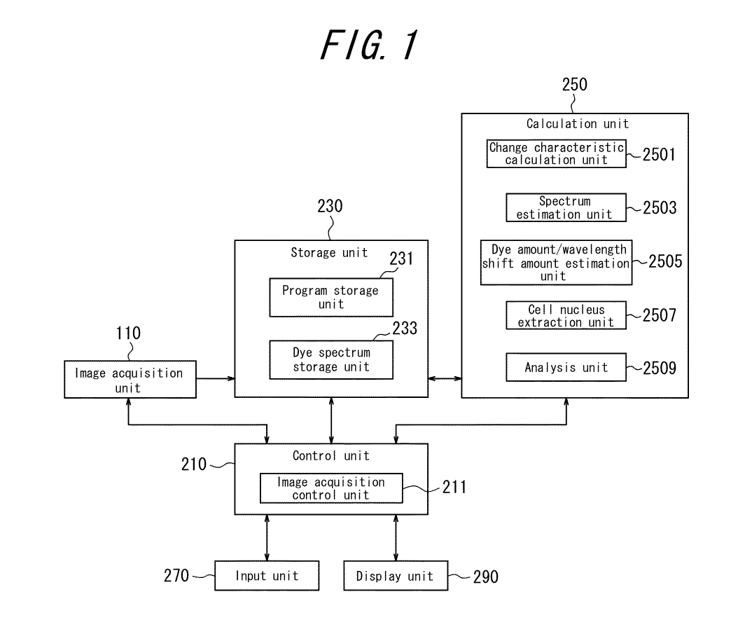

FIG. 1 is a block diagram illustrating the functional structure of main portions of an image processing device according to Embodiment 1 of the present invention. This image processing device is formed by a microscope and a computer, such as a personal computer, and includes an image acquisition unit 110, an input unit 270, a display unit 290, a calculation unit 250, a storage unit 230, and a control unit 210 that controls each of the other units.

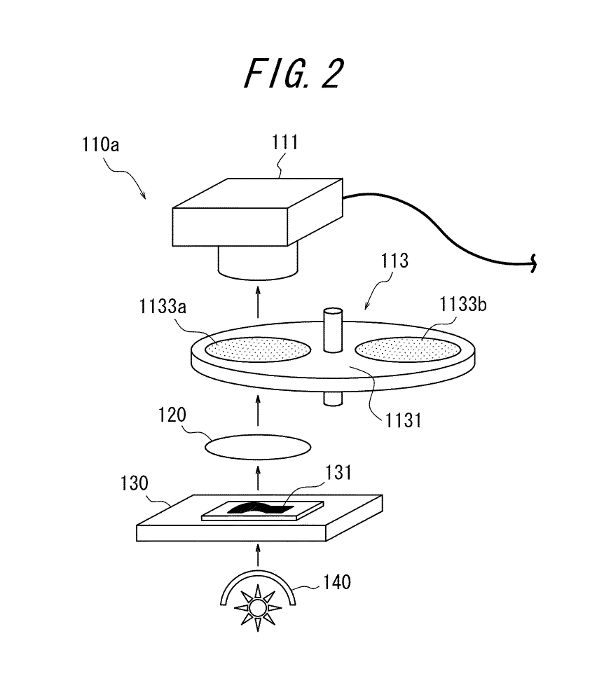

The image acquisition unit 110 acquires a multiband image (in the present embodiment, a six-band image), and for example as illustrated in FIG. 2, includes an RGB camera 111 and a filter unit 113 for restricting the wavelength band of light that forms an image on the RGB camera 111 to be in a predetermined range.

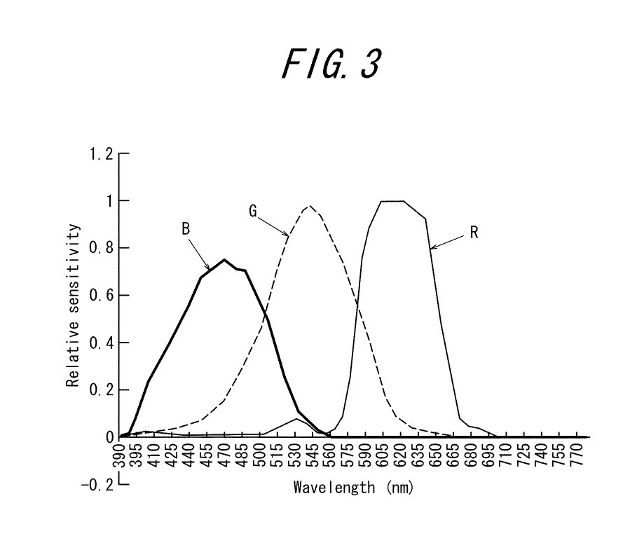

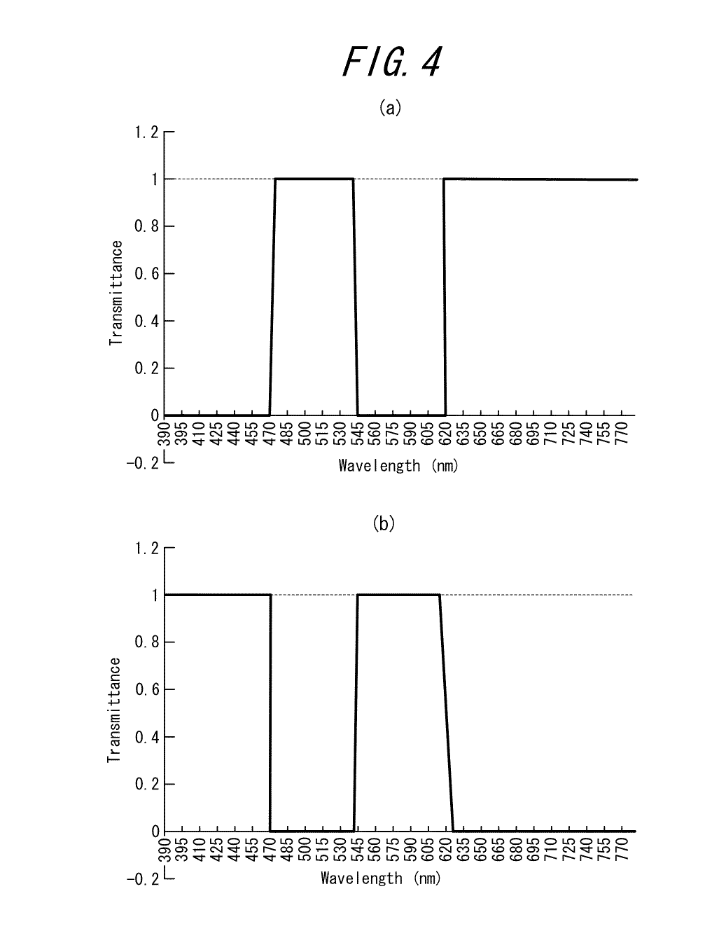

The RGB camera 111 includes an imaging element such as a Charge Coupled Device (CCD), a Complementary Metal Oxide Semiconductor (CMOS), or the like and for example has the spectral sensitivity characteristics of the red (R), green (G), and blue (B) bands as illustrated in FIG. 3. The filter unit 113 restricts the wavelength band of light that forms an image on the RGB camera 111 to be in a predetermined range and includes a rotary filter switching unit 1131. The filter switching unit 1131 holds two optical filters 1133a and 1133b having different spectral transmittance characteristics so as to divide the transmission wavelength range of each of the R, G, and B bands in two FIG. 4(a) illustrates the spectral transmittance characteristics of one of the optical filters 1133a, and FIG. 4(b) illustrates the spectral transmittance characteristics of the other optical filter 1133b.

The control unit 210 then performs first imaging by positioning the optical filter 1133a, for example, to be in the light path from an illumination unit 140 to the RGB camera 111, so that upon an illumination unit 140 illuminating a target sample 131 mounted on a light-receiving position movement unit 130, the transmitted light passes through an imaging lens 120 and the optical filter 1133a to form an image on the RGB camera 111. Next, the control unit 210 similarly performs second imaging by causing the filter switching unit 1131 to rotate so as to position the optical filter 1133b to be in the light path from the illumination unit 140 to the RGB camera 111.

As a result, different three-band images are obtained by the first imaging and the second imaging, yielding a multiband image with a total of six bands. The acquired image of the target sample 131 is stored in the storage unit 230.

Note that the number of optical filters provided in the filter unit 113 is not limited to two. Three or more optical filters may be used to acquire an image with even more bands. Furthermore, the filter unit 113 may be omitted and the image acquisition unit 110 configured to acquire only an RGB image with the RGB camera 111. The image acquisition unit 110 may also be configured by a multispectral camera, for example, provided with a liquid crystal tunable filter or an acoustic tunable filter and may acquire a multispectral image of a target sample (stained sample) using the multispectral camera.

In FIG. 1, the input unit 270 is implemented for example by an input device such as a keyboard, mouse, touch panel, variety of switches, or the like and outputs an input signal to the control unit 210 in response to operation input.

The display unit 290 is implemented by a display device such as a Liquid Crystal Display (LCD), Electro Luminescence (EL) display, Cathode Ray Tube (CRT) display, or the like and displays a variety of images based on display signals input from the control unit 210.

The calculation unit 250 includes a change characteristic calculation unit 2501, a spectrum estimation unit 2503, a dye amount/wavelength shift amount estimation unit 2505, a cell nucleus extraction unit 2507, and an analysis unit 2509. The calculation unit 250 is implemented by hardware such as a CPU.

The storage unit 230 includes a program storage unit 231 storing an image processing program that causes the image processing device to operate and a dye spectrum storage unit 233 storing dye spectra k_{H}(λ), k_{E}(λ), and k_{R}(λ) in accordance with the staining method used to stain the target sample. The storage unit 230 stores data used in execution of the image processing program. The storage unit 230 is implemented by various types of IC memory or internal memory, including ROM or RAM such as re-recordable flash memory, by a hard disk connected with a data communications terminal, by an information storage medium such as a CD-ROM and a corresponding reader, or the like.

The control unit 210 includes an image acquisition control unit 211 that controls operation of the image acquisition unit 110 to acquire an image of a target sample. Based on the input signal input from the input unit 270, the image input from the image acquisition unit 110, the program and data stored in the storage unit 230, and the like, the control unit 210 comprehensively controls overall operations by, for example, transmitting instructions and data to the units constituting the image processing device. The control unit 210 is implemented by hardware such as a CPU.

In the above structure, the dye spectra k_{H}(λ), k_{E}(λ), and k_{R}(λ) stored in the dye spectrum storage unit 233 of the storage unit 230 are, as described above, calculated for example by the Lambert-Beer law, based on spectral transmittance measured for samples individually stained with the dyes H, E, and R. It is known that the spectra for the dyes shift in the wavelength direction due to differences in tissues.

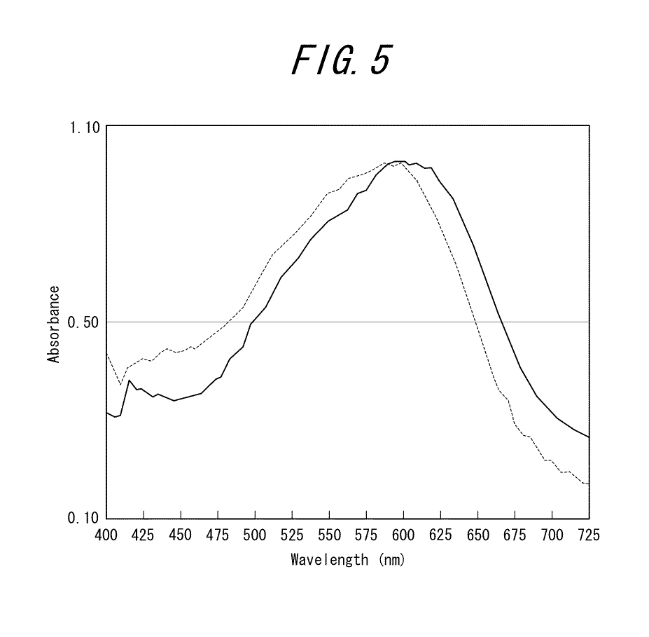

FIG. 5 illustrates the absorbance spectra of the cell nucleus and cytoplasm in a sample with simple H staining. In FIG. 5, the solid line represents the absorbance spectrum of the cell nucleus, and the dashed line represents the absorbance spectrum of the cytoplasm. As is clear from FIG. 5, in the sample with simple H staining, the absorbance spectrum of the cell nucleus is shifted in the 600 nm to 720 nm region towards longer wavelengths by approximately 10 nm as compared to the absorbance spectrum of the cytoplasm. This indicates that for some reason due to a difference in tissue, the dye spectrum is shifted in the wavelength direction.

The following describes operations by the image processing device according to the present embodiment.

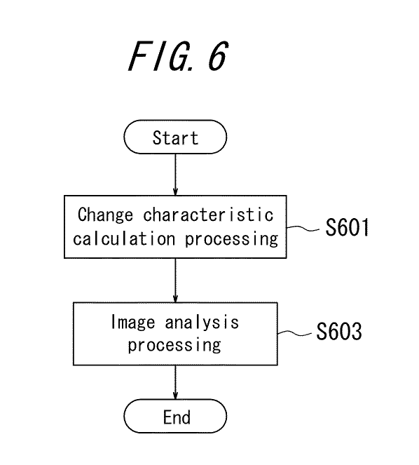

FIG. 6 is a flowchart providing an overview of operations by the image processing device according to the present embodiment. First, the image processing device according to the present embodiment performs change characteristic calculation processing to calculate the change characteristic in the wavelength direction of the dye spectrum (step S601). Next, the image processing device performs image analysis processing to analyze a target sample image (stained sample image) based on the change characteristic calculated during the change characteristic calculation processing (step S603).

During the change characteristic calculation processing, the control unit 210 reads the dye spectrum of the H stain k_{H}(λ) stored in the dye spectrum storage unit 233 of the storage unit 230, and the change characteristic calculation unit 2501 in the calculation unit 250 differentiates the read dye spectrum k_{H}(λ) to calculate the change characteristic k_{H}′(λ) in the wavelength direction. In order to seek the change characteristic of another dye, the spectrum of that dye may be differentiated. The calculation result of the change characteristic calculation processing is stored in the storage unit 230.

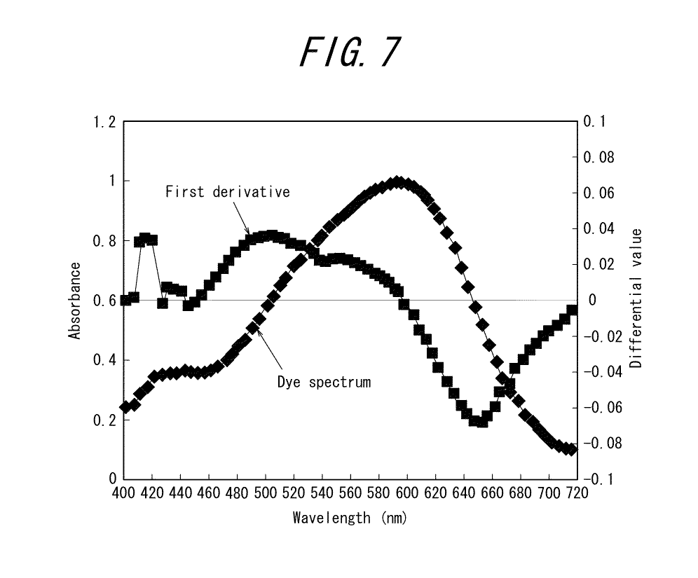

FIG. 7 illustrates the dye spectrum of the H stain k_{H}(λ) stored in the dye spectrum storage unit 233 and the first derivative thereof, i.e. the change characteristic k_{H}′(λ).

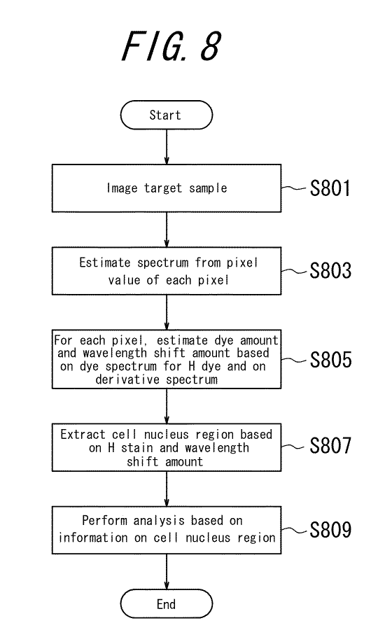

FIG. 8 is a flowchart providing an overview of the image analysis processing in FIG. 6. First, via the image acquisition control unit 211, the control unit 210 controls operation of the image acquisition unit 110 to acquire an image of the target sample 131 (step S801). Next, via the spectrum estimation unit 2503 in the calculation unit 250, the control unit 210 estimates the spectrum based on the pixel values of the acquired target sample image (step S803). In other words, the estimated value \hat{T}(x) of the spectral transmittance is estimated from the pixel value G(x) of the estimated target pixel for the corresponding sample point in the target sample by the above-described Equation (5). Equation (5) is reproduced below.

\hat{T}(x)=WG(x) (5)

Next, via the dye amount/wavelength shift amount estimation unit 2505 in the calculation unit 250, the control unit 210 estimates the dye amounts and the wavelength shift amount based on the estimated spectral transmittance \hat{T}(x) (step S805). In other words, based on the dye spectra k_{H}(λ), k_{E}(λ), and k_{R}(λ), which are stored in the dye spectrum storage unit 233 and are in accordance with the staining method used to stain the target sample, and based on the change characteristic k_{H}′(λ), the dye amount/wavelength shift amount estimation unit 2505 estimates the dye amount for each staining method and the wavelength shift amount at the sample point corresponding to an arbitrary point x of the target sample image. Specifically, based on the estimated value \hat{T}(x) of the spectral transmittance at the point x of the target sample image, the dye amount \hat{d}_{H} fixed to a sample point of the target sample corresponding to the point x is estimated with Equation (26) below.

$$( \begin{matrix}{\hat{d}}_{H} \\ {\hat{d}}_{H} Δ {λ}_{H} \\ {\hat{d}}_{E} \\ {\hat{d}}_{R}\end{matrix} ) = {( \begin{matrix}{k}_{H} ( {λ}_{1} ) & {k}_{H}^{′} ( {λ}_{1} ) & {k}_{E} ( {λ}_{1} ) & {k}_{R} ( {λ}_{1} ) \\ {k}_{H} ( {λ}_{2} ) & {k}_{H}^{′} ( {λ}_{2} ) & {k}_{E} ( {λ}_{2} ) & {k}_{R} ( {λ}_{2} ) \\ {k}_{H} ( {λ}_{3} ) & {k}_{H}^{′} ( {λ}_{3} ) & {k}_{E} ( {λ}_{3} ) & {k}_{R} ( {λ}_{3} )\end{matrix} )}^{- 1} ( \begin{matrix}\hat{a} ( x , {λ}_{1} ) \\ \hat{a} ( x , {λ}_{2} ) \\ \hat{a} ( x , {λ}_{3} )\end{matrix} ) \qquad ( 26 )$$

In Equation (26), \hat{d}_{H}Δλ_{H} is replaced based on Equation (27) below.

d_{H}′=\hat{d}_{H}Δλ_{H} (27)

The wavelength shift amount Δλ_{H} is calculated with Equation (28). The dye amounts and the wavelength shift amount can thus be estimated while reflecting each correlation with change.

$$Δ {λ}_{H} = \frac{{d}_{H}^{′}}{{\hat{d}}_{H}} \qquad ( 28 )$$

Subsequently, via the cell nucleus extraction unit 2507 in the calculation unit 250, the control unit 210 calculates the cell nucleus region based on the estimated wavelength shift amount Δλ_{H} (step S807). For example, the cell nucleus region is extracted by performing clustering processing, for example by the k-means method, on an image where the wavelength shift amount Δλ_{H} of the H stain is in a predetermined range (for example, from −5 nm to 5 nm). Alternatively, the cell nucleus region may be extracted by comparing each pixel in the image with the wavelength shift amount Δλ_{H} to an appropriate threshold (wavelength shift amount).

Next, via the analysis unit 2509 in the calculation unit 250, the control unit 210 analyzes the target sample image based on the information on the extracted cell nucleus region (step S809). A variety of analysis methods are possible as the method for the target sample image. For example, the above-described technique disclosed in PTL 1 may be adopted to calculate the image features in the extracted cell nucleus region, and based on the image features, to provide information useful for pathological diagnosis.

According to the image processing device of the present embodiment, the cell nucleus is thus extracted based on the wavelength shift amount of the H stain, and therefore the cell nucleus region can reliably be extracted even for a thinly H stained nucleus with little amount of H dye. The target sample image can thus be analyzed to a high degree of accuracy in line with phenomena of the target sample.

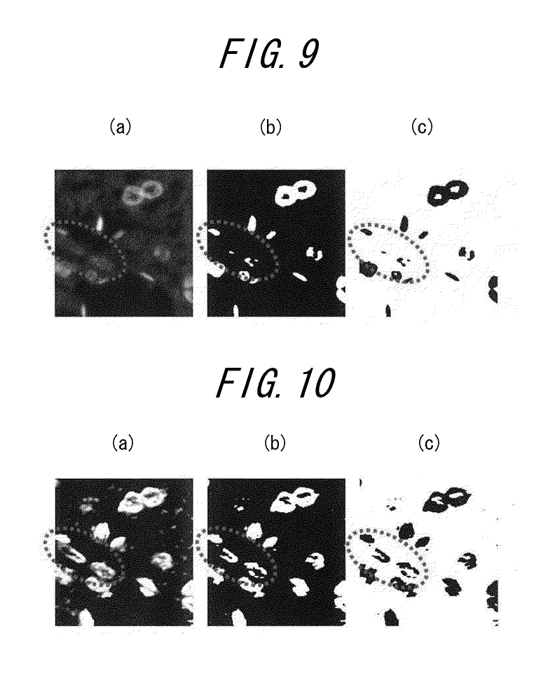

For example, when extracting the cell nucleus region based on the dye amount of the H stain as disclosed in the above-described PTL 1, the image based on the dye amount is as in FIG. 9(a), and the amount of H stain for the faint cell nucleus in the region enclosed by a dashed line is small. As a result, upon identifying pixels with an H stain amount larger than a threshold to be the cell nucleus, the cell nucleus region becomes as shown in FIG. 9(b), and the identification accuracy decreases for the cell nucleus with a small H stain amount. FIG. 9(c) shows an image for regions other than the cell nucleus region.

By contrast, if the cell nucleus is extracted based on the wavelength shift amount of the H stain as in the present embodiment, then the image based on the wavelength shift amount of the H stain is as shown in FIG. 10(a), and even the thin cell nucleus in the region enclosed by a dashed line appears prominently. Accordingly, if for example the cell nucleus region is extracted by comparing each pixel in the image of FIG. 10(a) with an appropriate threshold (wavelength shift amount), then the cell nucleus region can be extracted even for a thin cell nucleus, as shown in FIG. 10(b), thereby improving identification accuracy of the cell nucleus. FIG. 10(c) shows an image for regions other than the cell nucleus region.

Furthermore, in the present embodiment, the spectrum estimation unit 2503 estimates the spectra based on the pixel values of the target sample image, thereby allowing for accurate analysis not only of a multiband image but also of a target sample image such as an RGB image. In this case, the structure of the image acquisition unit 110 can be simplified.

### Embodiment 2

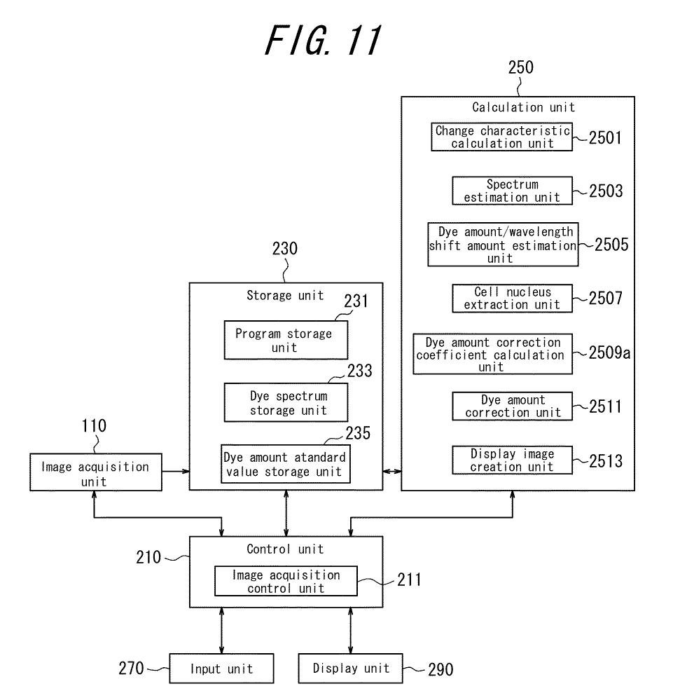

FIG. 11 is a block diagram illustrating the functional structure of main portions of an image processing device according to Embodiment 2 of the present invention. In the context of the structure of Embodiment 1, this image processing device corrects the dye amount based on the information on the cell nucleus region and displays the target sample image on the display unit 290 based on the corrected dye amount. Accordingly, instead of the analysis unit 2509 in FIG. 1, the calculation unit 250 includes a dye amount correction coefficient calculation unit 2509a, a dye amount correction unit 2511, and a display image creation unit 2513. The storage unit 230 is provided with a dye amount standard value storage unit 235 that stores a dye amount standard value d_{std}(i) for the cell nucleus region. The remaining structure is similar to Embodiment 1, and therefore a description thereof is omitted.

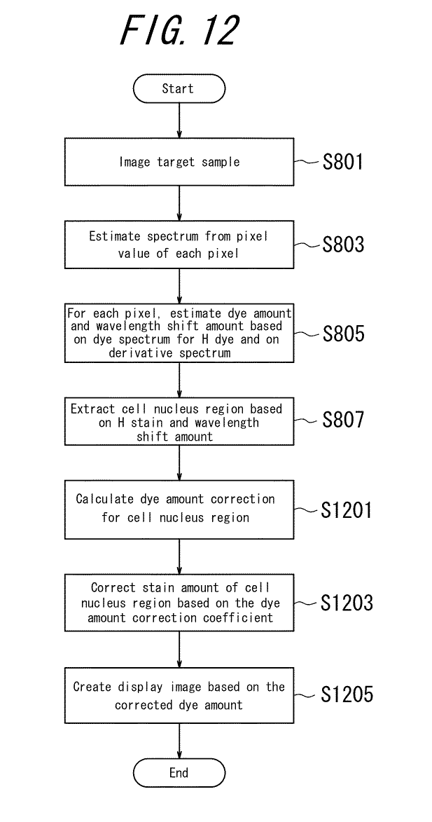

FIG. 12 is a flowchart providing an overview of operations by the image processing device according to the present embodiment. In FIG. 12, the processing in steps S801 to S807 is the same as in steps S801 to S807 in FIG. 8, and therefore a description thereof is omitted. In the present embodiment, once the cell nucleus region is extracted by the cell nucleus extraction unit 2507 in step S807, the control unit 210 calculates, via the dye amount correction coefficient calculation unit 2509a, a dye amount correction coefficient coefᵢ for the cell nucleus region of the target sample image based on the information on the extracted cell nucleus region (step S1201).

Therefore, the dye amount correction coefficient calculation unit 2509a first calculates the dye amount average \hat{d}(i) of each stain in the cell nucleus region extracted by the cell nucleus extraction unit 2507. Next, the dye amount correction coefficient calculation unit 2509a calculates the dye amount correction coefficient coefᵢ with Equation (29) below, based on the calculated dye amount average \hat{d}(i) and on the dye amount standard value d_{std}(i) for the cell nucleus region stored in the dye amount standard value storage unit 235 of the storage unit 230.

$${coef}_{i} = \frac{{d}_{std} ( i )}{\hat{d} ( i )} \qquad ( 29 )$$

Subsequently, via the dye amount correction unit 2511, the control unit 210 calculates the corrected dye amount \hat{d}*(x) with Equation (30) below using the calculated dye amount correction coefficient coefᵢ (step S1203).

\hat{d}*(x)=\hat{d}(x)·coefᵢ (30)

Next, via the display image creation unit 2513, the control unit 210 creates a display image based on the corrected dye amount \hat{d}*(x) (step S1205). Therefore, the display image creation unit 2513 first composes a corrected spectrum based on the calculated corrected dye amounts \hat{d}_{H}*, \hat{d}_{E}*, and \hat{d}_{R}. In other words, in accordance with the above-described Equation (21), a new spectral absorbance ã(x, λ) is calculated at each point x. Equation (21) is reproduced below.

ã*(x,λ)=k_{H}(λ)·\hat{d}_{H}*+k_{E}(λ)·\hat{d}_{E}*+k_{R}(λ)·\hat{d}_{R} (21)

Subsequently, in accordance with the above-described Equation (23), a new spectral transmittance t*(x, b) is calculated at each point x. Equation (23) is reproduced below.

t*(x,λ)=^{-a}*^{(x,λ)} (23)

The display image creation unit 2513 obtains T*(x) by repeating the above processing D times in the wavelength direction. T*(x) is a D×1 matrix corresponding to t*(x, λ). Next, the display image creation unit 2513 composes a corrected image based on the composite spectral transmittance T*(x). In other words, in accordance with the above-described Equation (25), a new pixel value G*(x) is calculated at each point x. As a result, the pixel value G*(x) of a sample for which the dye amounts have been virtually changed can be composed. Equation (25) is reproduced below,

G*(x)=HT*(x) (25)

Subsequently, the control unit 210 displays the display image, composed by the display image creation unit 2513 as described above, on the display unit 290.

In this way, according to the image processing device of the present embodiment, the color of the extracted cell nucleus region is normalized regardless of the dye amount of the H stain to create and display a display image for the target sample image, thereby allowing fat display of an image in which the cell nucleus region exhibits no variation in the staining condition. As a result, the target sample image can visually be analyzed easily and to a high degree of accuracy.

### Embodiment 3

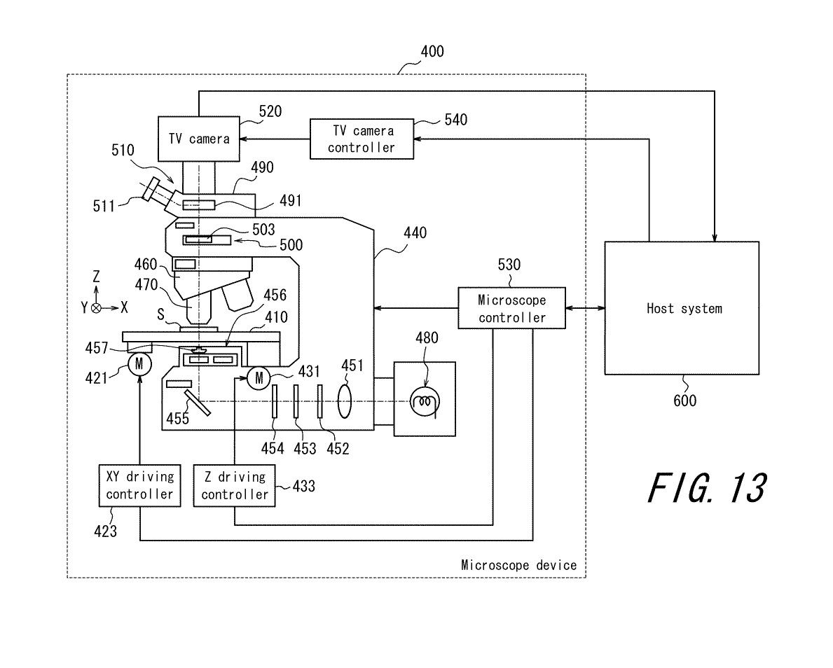

FIG. 13 is a block diagram illustrating the functional structure of main portions of a virtual microscope system according to Embodiment 3 of the present invention. The virtual microscope system acquires a virtual slide image of a stained sample and includes a microscope device 400 and a host system 600.

The microscope device 400 includes a microscope body 440 having a reversed square C shape when viewed from the side, a light source 480 attached at the back side of the bottom of the microscope body 440, and a lens tube 490 placed on the top of the microscope body 440. The microscope body 440 supports a motor-operated stage 410 on which a target sample S is placed and holds an objective lens 470 via a revolver 460. A binocular unit 510 for visual observation of a sample image of the target sample S and a TV camera 520 for capturing the sample image of the target sample S are attached to the lens tube 490. In other words, the microscope device 400 corresponds to the image acquisition unit 110 in FIG. 1 and FIG. 11. In this context, the optical axis direction of the objective lens 470 is defined as the Z direction, and the plane perpendicular to the Z direction is defined as the XY plane.

The motor-operated stage 410 is configured to move freely in the XYZ direction. In other words, the motor-operated stage 410 can move freely within the XY plane via a motor 421 and an XY driving controller 423 that controls driving of the motor 421. Under the control of a microscope controller 530, the XY driving controller 423 detects a predetermined origin position of the motor-operated stage 410 in the XY plane with an XY position origin sensor (not illustrated) and controls the driving amount of the motor 421 with reference to the origin position in order to move the observation location on the target sample S. The XY driving controller 423 outputs the X position and the Y position of the motor-operated stage 410 during observation to the microscope controller 530 as needed.

The motor-operated stage 410 can also move freely within the Z plane via a motor 431 and a Z driving controller 433 that controls driving of the motor 431. Under the control of the microscope controller 530, the Z driving controller 433 detects a predetermined origin position of the motor-operated stage 410 in the Z plane with a Z position origin sensor (not illustrated) and controls the driving amount of the motor 431 with reference to the origin position in order to move the target sample S into focus at any Z position within a predetermined height range. The Z driving controller 433 outputs the Z position of the motor-operated stage 410 during observation to the microscope controller 530 as needed.

The revolver 460 is rotatably held with respect to the microscope body 440 and positions the objective lens 470 above the target sample S. The objective lens 470 is attached to the revolver 460 with other objective lenses of different magnification level (magnification of observation) and can be exchanged with these objective lenses. The objective lens 470 that is inserted in the light path of the observation light for observation of the target sample S can be selectively switched by rotating the revolver 460.

The microscope body 440 includes, at the bottom thereof, an illumination optical system for transmitting light through the target sample S. The illumination optical system includes a collector lens 451 that collects the illumination light emitted by the light source 480, an illumination system filter unit 452, a field stop 453, an aperture stop 454, a folding mirror 455 that deflects the light path of the illumination light along the light axis of the objective lens 470, a condenser optical element unit 456, a top lens unit 457, and the like provided at appropriate positions along the light path of the illumination light. The illumination light emitted from the light source 480 illuminates the target sample S via the illumination optical system, and transmitted light passing therethrough enters the objective lens 470 as observation light.

The microscope body 440 includes a filter unit 500 in the upper part thereof. The filter unit 500 rotatably holds at least two optical filters 503 for restricting the wavelength band of light that forms the sample image to be in a predetermined range and inserts these optical filters 503 appropriately further along the light path of observation light than the objective lens 470. The filter unit 500 corresponds to the filter unit 113 in FIG. 2. Note that while the optical filters 503 are illustrated as being positioned further along than the objective lens 470, the position is not limited in this way, and the optical filters 503 may be positioned anywhere along the light path from the light source 480 to the TV camera 520. The observation light passing through the objective lens 470 enters the lens tube 490 via the filter unit 500.

The lens tube 490 includes therein a beam splitter 491 that switches the light path of the observation light passing through the filter unit 500 so as to conduct the observation light to the binocular unit 510 and the TV camera 520. The sample image of the target sample S is conducted into the binocular unit 510 by the beam splitter 491 and visually observed by the microscope operator via an eyepiece 511, or the sample image is captured by the TV camera 520. The TV camera 520 includes an imaging device, such as a CCD or CMOS, that captures the sample image (specifically, a sample image in the field of view of the objective lens 470) and outputs image data on the captured sample image to the host system 600. In other words, the TV camera 520 corresponds to the RGB camera 111 in FIG. 2.

Furthermore, the microscope device 400 includes the microscope controller 530 and a TV camera controller 540. Under the control of the host system 600, the microscope controller 530 comprehensively controls operations by the units constituting the microscope device 400. For example, the microscope controller 530 adjusts the units of the microscope device 400 in association with observation of the target sample S. Such adjustments include rotating the revolver 460 to switch the objective lens 470 positioned in the light path of the observation light, controlling the light source 480 and switching various optical devices in accordance with factors such as the magnification level of the switched objective lens 470, and instructing the XY driving controller 423 and the Z driving controller 433 to move the motor-operated stage 410. The microscope controller 530 also notifies the host system 600 of the status of the units as necessary.

Under the control of the host system 600, the TV camera controller 540 controls imaging operations of the TV camera 520 by driving the TV camera 520, for example by switching automatic gain control on and off, setting the gain, switching automatic exposure control on and off, and setting the exposure time.

The host system 600, on the other hand, includes the input unit 270, display unit 290, calculation unit 250, storage unit 230, and control unit 210 illustrated in Embodiment 1 or Embodiment 2. The host system 600 is implemented with a well-known hardware configuration including a CPU, a video board, a main storage device such as main memory (RAM), an external storage device such as a hard disk or any of a variety of storage media, a communications device, an output device such as a display device or a printing device, an input device or an interface device for connecting with external input, and the like. Accordingly, a general-purpose computer such as a work station or a personal computer, for example, can be used for the host system 600.

The virtual microscope system according to the present embodiment controls operations by the units constituting the microscope device 400 in accordance with a virtual slide (VS) image generation program that includes the image processing program stored in a storage unit of the host system 600. In this way, a plurality of target sample images of the target sample S captured piece by piece by the TV camera 520 of the microscope device 400 as a multiband image are processed as described in Embodiment 1 or Embodiment 2 so as to generate a VS image. The VS image data (multiband image data) is stored in the storage unit of the host system 600.

The VS image generation program is a program for implementing processing to generate a VS image of the target sample. A VS image refers to an image generated by stitching together two or more images captured as a multiband image by the microscope device 400. For example, a VS image is an image generated by stitching together a plurality of high-resolution images of portions of the target sample S captured using a high power objective lens 470. A VS image is thus a wide-field, high-resolution multiband image of the entire target sample S.

The host system 600 performs operations such as transmitting instructions and data to the units constituting the host system 600 based on input signals input from the input unit 270 illustrated in Embodiment 1 or Embodiment 2, the status of each unit in the microscope device 400 input from the microscope controller 530, image data input from the TV camera 520, the program, data, and the like stored in the storage unit 230 illustrated in Embodiment 1 or Embodiment 2, and the like. Furthermore, the host system 600 comprehensively controls overall operations by the virtual microscope system in accordance with operation instructions from the units of the microscope device 400 with respect to the microscope controller 530 and the TV camera controller 540.

Therefore, the virtual microscope system according to the present embodiment can achieve the same effects as those of the image processing device illustrated in Embodiment 1 and Embodiment 2.

The present invention is not limited to the above embodiments, but rather a variety of modifications and changes are possible. For example, in Embodiment 1 or Embodiment 2, the spectrum estimation unit 2503 may be omitted. Furthermore, the image, acquisition unit 110 need not be provided with an imaging function, and instead, stained image data for a target sample obtained separately by imaging may be acquired via a recording medium or over a communications line.

The present invention is not limited to the above-described image processing device or virtual microscope system but may also be implemented as an image processing method, an image processing program, or a recording medium having recorded thereon a program, all of which substantially execute the processing by the image processing device, or virtual microscope system. Accordingly, the present invention should be understood as including these aspects as well.

### REFERENCE SIGNS LIST

110: Image acquisition unit
210: Control unit
230: Storage unit
233; Dye spectrum storage unit
235: Dye amount standard value storage unit
250: Calculation unit
2501: Change characteristic calculation unit
2503: Spectrum estimation unit
2505: Dye amount/wavelength shift amount estimation unit
2507: Cell nucleus extraction unit
2509: Analysis unit
2509a: Dye amount correction coefficient calculation unit
2511: Dye amount correction unit
2513: Display image creation unit
270: Input unit
290: Display unit
400: Microscope device
600: Host system

1. An image processing device for processing a stained sample image including hematoxylin stain, comprising:
a dye spectrum storage unit configured to store a dye spectrum of dye used in staining;
a change characteristic calculation unit configured to calculate a change characteristic in a wavelength direction of the dye spectrum based on the dye spectrum;
a dye amount/wavelength shift amount estimation unit configured to estimate at least a dye amount of the hematoxylin stain and a shift amount in the wavelength direction for each pixel in the stained sample image based on the dye spectrum and the change characteristic; and
a cell nucleus extraction unit configured to extract a cell nucleus region of the stained sample image based on the shift amount estimated in the wavelength direction.

2. The image processing device according to claim 1, further comprising:
a dye amount standard value storage unit configured to store a dye amount standard value for a cell nucleus;
a dye amount correction coefficient calculation unit configured to calculate a dye amount correction coefficient for a cell nucleus in order to correct a dye amount of the cell nucleus region extracted by the cell nucleus extraction unit to be the dye amount standard value; and
a dye amount correction unit configured to correct the dye amount of each pixel based on the dye amount correction coefficient.

3. The image processing device according to claim 1, further comprising:
a spectrum estimation unit configured to estimate a spectrum from a pixel value of each pixel in the stained sample image, wherein
the dye amount/wavelength shift amount estimation unit estimates the shift amount in the wavelength direction based additionally on the spectrum estimated by the spectrum estimation unit.

4. The image processing device according to claim 1, further comprising:
a display image creation unit configured to create a display image based on information on the cell nucleus region extracted by the cell nucleus extraction unit.

5. A method for image processing to process a stained sample image including hematoxylin stain, comprising the steps of:
acquiring a dye spectrum of dye used in staining;
calculating a change characteristic in a wavelength direction of the dye spectrum based on the dye spectrum;
estimating at least a dye amount of the hematoxylin stain and a shift amount in the wavelength direction for each pixel in the stained sample image based on the dye spectrum and the change characteristic; and
extracting a cell nucleus region of the stained sample image based on the shift amount estimated in the wavelength direction.

6. A program for image processing to process a stained sample image including hematoxylin stain, the program causing a computer to perform the steps of:
acquiring a dye spectrum of dye used in staining;
calculating a change characteristic in a wavelength direction of the dye spectrum based on the dye spectrum;
estimating at least a dye amount of the hematoxylin stain and a shift amount in the wavelength direction for each pixel in the stained sample image based on the dye spectrum and the change characteristic; and
extracting a cell nucleus region of the stained sample image based on the shift amount estimated in the wavelength direction.

7. A virtual microscope system for acquiring a virtual slide image of a stained sample, comprising:
an image acquisition unit configured to acquire a stained sample image by imaging the stained sample using a microscope;
a dye spectrum storage unit configured to store a dye spectrum of dye used in staining;
a change characteristic calculation unit configured to calculate a change characteristic in a wavelength direction of the dye spectrum based on the dye spectrum;
a dye amount/wavelength shift amount estimation unit configured to estimate at, least a dye amount of the hematoxylin stain and a shift amount in the wavelength direction for each pixel in the stained sample image based on the dye spectrum and the change characteristic; and
a cell nucleus extraction unit configured to extract a cell nucleus region of the stained sample image based on the shift amount estimated in the wavelength direction, wherein
the virtual slide image of the stained sample is acquired based on information on the cell nucleus region extracted by the cell nucleus extraction unit.
